(19) United States
(12) Patent Application Publication
(10) Pub. No.: US 2025/0068948 A1
(43) Pub. Date: Feb. 27, 2025

(54) EFFICIENT COMPUTATIONAL REASONING WITH IMPRECISE KNOWLEDGE

(71) Applicant: INTERNATIONAL BUSINESS MACHINES CORPORATION, ARMONK, NY (US)

(72) Inventors: Radu Marinescu, Dublin (IE); Debarun Bhattacharjya, New York, NY (US); Alexander Gray, Yonkers, NY (US); Francisco Barahona, White Plains, NY (US); Tian Gao, Berkeley Heights, NJ (US); Ryan Nelson Riegel, Carrollton, GA (US); Haifeng Qian, Mount Kisco, NY (US)

(21) Appl. No.: 18/454,037

(22) Filed: Aug. 22, 2023

(51) Int. Cl. G06N 7/01

(52) U.S. Cl. CPC G06N 7/01

(57) ABSTRACT

A computer-implemented method for facilitating reasoning under conditions of uncertainty includes receiving input including a set of logic formulas, a set of intervals representing lower and upper bounds on the truth values of the formulas in the set of logic formulas, and a query formula. The logic formulas can be converted into a logical credal network (LCN) representation and a factor graph representation of the LCN representation can be created. The method can output a probability interval [l, u] such that l≤P(q)≤u, where P(q) represents a query for a given probability interval.

### BACKGROUND

The present disclosure generally relates to systems and methods for computerized reasoning using multiple knowledge sources, and more particularly, to a computer-implemented method, a computer system, and a computer program product that provides an efficient inference method for logical credal networks (LCNs) that allows the system to scale to large and practical LCN models.

Many real-world applications require efficient handling of uncertainty and a compact representation of a wide variety of knowledge. Graphical models, such as Bayesian networks or Markov networks, provide a powerful framework for reasoning about uncertainty while classical (first-order) logic can naturally be used to represent compactly complex concepts and relationships that include expert knowledge.

Consequently, probabilistic logic, which combines probability and logic in a principled manner, has emerged over the years as a unified framework to deal effectively with these complex applications. While some of these formalisms associate a single real value to the logical formulas to represent the uncertainty around their truth values, others relax this requirement and allow specifying lower and upper probability bounds on logical formulas.

In practice, it is often the case that multiple sources of imprecise knowledge need to be combined to solve a problem more effectively. For example, in a credit card fraud detection application, it would be desirable to combine a statistical model capturing the uncertainty around historical transaction data with probabilistic logic rules expressing imprecise expert knowledge about the domain in order to predict future fraudulent transactions more accurately.

### SUMMARY

In one embodiment, a system and method are provided that provide an iterative message-passing algorithm, herein referred to as ARIEL, for approximate inference in LCNs. According to embodiments of the present disclosure, the approach propagates messages in an iterative manner between the nodes of a factor graph associated with the LCN. The messages include both lower and upper bounds on the marginal probability of LCN's variables and the lower and upper bounds are tightened iteratively. These messages solve considerably smaller local non-linear constraint programs as compared with those in exact inference. Thus, aspects of the present disclosure can reduce computational overhead associated with reasoning with imprecise knowledge using LCNs.

The system and methods of the present disclosure provide promising results that show conclusively that ARIEL is able to produce high quality solutions compared with conventional approaches. Moreover, it is shown that ARIEL scales to much larger problems than previously considered with conventional approaches, while maintaining solution quality. This is important because it permits the system and method to tackle practical problems, especially first-order logic LCNs with large domains whose groundings could translate to many hundreds of variables that may provide computational challenges.

In one embodiment, a computer implemented method and a computer program product can be configured to receive input including a set of logic formulas, a set of intervals representing lower and upper bounds on the truth values of the formulas in the set of logic formulas, and a query formula. The logic formulas can be converted into a logical credal network (LCN) representation and a factor graph representation can be created of the LCN representation. An output of a probability interval [l, u] such that l≤P(q)≤u can be provided, where P(q) represents a query for a given probability interval.

In another embodiment, a system includes a processor, a data bus coupled to the processor, a memory coupled to the data bus, and a computer-usable medium embodying a computer program code. The computer program code includes instructions executable by the processor and configured to receive input including a set of logic formulas, a set of intervals representing lower and upper bounds on the truth values of the formulas in the set of logic formulas, and a query formula. The logic formulas can be converted into a logical credal network (LCN) representation and a factor graph representation can be created of the LCN representation. An output of a probability interval [l, u] such that l≤P(q)≤u can be provided, where P(q) represents a query for a given probability interval.

These and other features will become apparent from the following detailed description of illustrative embodiments thereof, which is to be read in connection with the accompanying drawings.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps.

FIG. 1 shows a schematic representation of a method for reasoning with imprecise knowledge, consistent with an illustrative embodiment;

FIG. 2 shows a primal graph of an LCN, consistent with an illustrative embodiment;

FIG. 3 shows a factor graph for an LCN, consistent with an illustrative embodiment;

FIG. 4A shows a factor graph with variable-to-factor messages and factor-to-variable messages, consistent with an illustrative embodiment;

FIG. 4B shows an algorithm consistent with an illustrative embodiment;

FIGS. 5A and 5B show mean absolute errors MAE versus number of iterations used by methods for reasoning with imprecise knowledge, consistent with an illustrative embodiment;

FIG. 6 shows a flow chart illustrating a process consistent with an illustrative embodiment;

FIG. 7 is a functional block diagram illustration of a computer hardware platform that can be used to implement the method for reasoning with imprecise knowledge, consistent with an illustrative embodiment;

FIG. 8 provides the data of Table 1;

FIG. 9 provides the data of Table 2;

FIG. 10 provides the data of Table 3; and

FIG. 11 provides the data of Table 4.

### DETAILED DESCRIPTION

In the following detailed description, numerous specific details are set forth by way of examples to provide a thorough understanding of the relevant teachings. However, it should be apparent that the present teachings may be practiced without such details. In other instances, well-known methods, procedures, components, and/or circuitry have been described at a relatively high-level, without detail, to avoid unnecessarily obscuring aspects of the present teachings.

As described in greater detail below, aspects of the present disclosure provide a computer-implemented method, a system for performing the computer-implemented method, and a computer program code having instructions for performing the computer implemented method. The computer implemented method can include receiving input including a set of logic formulas, a set of intervals representing lower and upper bounds on the truth values of the formulas in the set of logic formulas, and a query formula. The logic formulas can be converted into a logical credal network (LCN) representation and a factor graph representation can be created of the LCN representation. An output of a probability interval [l, u] such that l≤P(q)≤u can be provided, where P(q) represents a query for a given probability interval. By use of the factor graph representation, the method can handle a significant amount of data while minimizing overall CPU time, as described in greater detail below.

In embodiments, which can be combined with the preceding embodiment, the computer-implemented method can further include computing node-to-factor and factor-to-node messages in the factor graph. In embodiments, which can be combined with the preceding embodiments, the node-to-factor and factor-to-node messages between nodes of the factor graph are lower and upper bounds on marginal probabilities. These messages can improve computing can help improve efficiency of the reasoning performed by the system.

In embodiments, which can be combined with one or more preceding embodiments, the method includes solving a quadratic program encoding of the node-to-factor and factor-to-node messages and the query formula to obtain l≤P(q)≤u. In embodiments, which can be combined with the preceding embodiment, the quadratic program is:

$${\sum }_{i = 1}^{K} {p}_{i} = 1 ,$$

$${p}_{i} \geq 0 , ∀ i = 1 , … , K ,$$

$${l}_{{v}^{′} \to {f}^{′}} \leq {\vec{A}}_{{v}^{′}} ⊙ \vec{p} \leq {u}_{{v}^{′} \to {f}^{′}} , ∀ {v}^{′} ∈ N ( {f}^{′} ) ,$$

$${\vec{A}}_{{v}^{′} ∧ {v}^{″}} ⊙ \vec{p} = ( {\vec{A}}_{{v}^{′}} ⊙ \vec{p} ) ( {\vec{A}}_{{v}^{″}} ⊙ \vec{p} ) , ∀ {v}^{′} \neq {v}^{′} ∈ N ( {f}^{′} ) ,$$

$$minimize / maximize {\vec{A}}_{p} ⊙ \vec{p} ,$$

where f′ is an auxiliary factor node corresponding to ρ, N(f′)={v1, . . . , vk} and A [symbol] is p's indicator vector. The algorithm can be used to efficiently provide reasoning using imprecise knowledge, thereby improving computing operation.

In embodiments, which can be combined with one or more preceding embodiments, the set of logic formulas includes at least one of a propositional logic formula or a first-order logic formula.

In embodiments, which can be combined with one or more preceding embodiments, the first-order-logic formula is universally and/or existentially quantified, and predicate arguments of the first-order-logic formula have finite domains of values. The logic formulas provide the basis for the LCN which, in turn, forms the basis for the factor graph representation used in determining the probability output.

In embodiments, which can be combined with one or more preceding embodiments, the method further includes combining multiple sources of imprecise knowledge for outputting the probability interval. The methods of the present invention can use noisy data from multiple sources with imprecise knowledge while still providing the reasoning.

Although the operational/functional descriptions described herein may be understandable by the human mind, they are not abstract ideas of the operations/functions divorced from computational implementation of those operations/functions. Rather, the operations/functions represent a specification for an appropriately configured computing device. As discussed in detail below, the operational/functional language is to be read in its proper technological context, i.e., as concrete specifications for physical implementations.

Accordingly, one or more of the methodologies discussed herein may provide a process model for reasoning with imprecise knowledge. This may have the technical effect of significantly reducing computing resources and overhead required for providing such inferences.

It should be appreciated that aspects of the teachings herein are beyond the capability of a human mind. It should also be appreciated that the various embodiments of the subject disclosure described herein can include information that is impossible to obtain manually by an entity, such as a human user. For example, the type, amount, and/or variety of information included in performing the process discussed herein can be more complex than information that could be reasonably be processed manually by a human user.

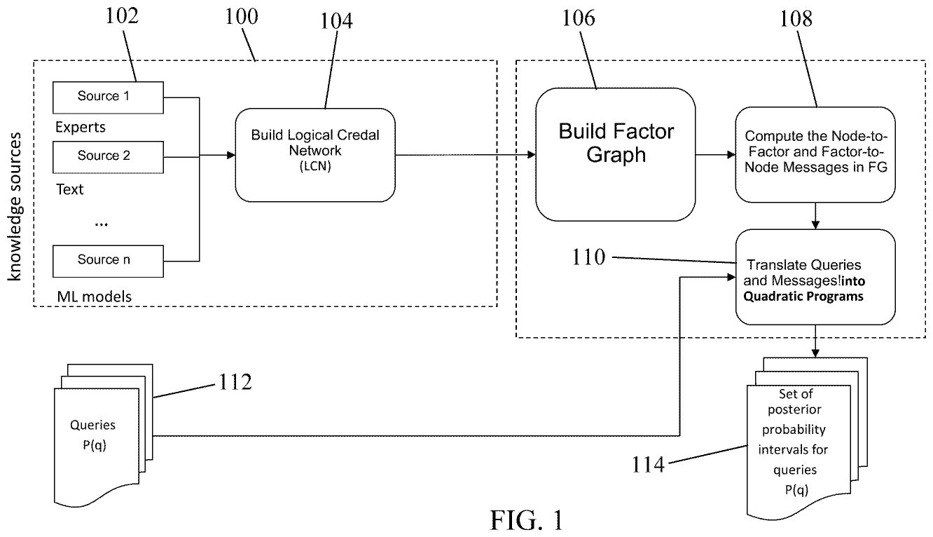

Referring to FIG. 1, an overview of a method for reasoning using imprecise knowledge from multiple sources 102 is shown. Further details for each block are provided in the following pages. At block 100, the sources 102 can be used to build a logical credal network 104, which, in turn, is used to build a factor graph 106. Messages, including node-to-factor and factor-to-node messages can be computed in the factor graph at 108. Queries P(q) 112 can be received and the system can translate the queries and messages into quadratic programs at 110. The system can output a set of posterior probability intervals for the queries at 114.

Logical Credal Networks (LCNs) are a recent probabilistic logic specifically designed for effective aggregation and reasoning over multiple sources of imprecise knowledge. An LCN expresses both probability bounds for propositional and first-order logic formulas with few restrictions and a Markov condition that is similar to Bayesian and Markov networks for capturing certain independence relations. However, a serious limitation of LCNs is that exact inference in these models is intractable because it implies solving a non-linear constraint program defined over an exponentially large set of variables and, therefore, is limited to relatively small problems.

An LCN [symbol] is defined by a set of probability sentences having one of the following two forms:

$${l}_{q} \leq P ( q ) \leq {u}_{q} \qquad ( 1 )$$

$${l}_{q \vert r} \leq P ( q \vert r ) \leq {u}_{q \vert r} \qquad ( 2 )$$

where q and r can be arbitrary propositional or first order logic (FOL) formulas and 0≤l_{q}≤u_{q}≤1, and 0≤l_{q|r}≤u_{q|r}≤1. Each sentence in [symbol] is further associated with a parameter τ∈{True, False} indicating whether the sentence implies dependence between the atomic formulas occurring in q.

An LCN represents the set of probability distributions (i.e., models) over all interpretations that satisfy a set of constraints given explicitly by sentences (1) and (2) together with a set of implied independence constraints between the LCN's atoms. It can be said that an LCN is consistent if it has at least one model. Otherwise, it is inconsistent.

The primal graph of an LCN [symbol] is a directed graph G that contains formula nodes associated with the formulas q and r in [symbol] 's sentences and atomic nodes associated with the atoms involved in those formulas, respectively. If a formula consists of a single atom, then G contains a single atomic node for that formula. For type (1) sentences, there is a directed edge from each of formula q's atomic nodes to q's formula node, while in case of type (2) sentences, G contains directed edges from formula r's atomic nodes to r's formula node, a directed edge from formula node r to formula node q, and directed edges from q's formula node to its corresponding atomic nodes. In addition, for all sentences with τ=True, G contains directed edges from the atomic nodes corresponding to q's atoms to the formula node q.

Given an LCN [symbol] and its primal graph G, the parents of an atomic node x, denoted by parents(x), is the set of atomic nodes y such that there exists a directed path (y→z₁→ . . . →zₖ→x) from y to x in G such that all intermediate nodes zᵢ (if any) are formula nodes. Similarly, the descendants of an atomic node x, denoted by descendants (x), is the set of atomic nodes y such that there exists a directed path (x→z₁→ . . . →zₖ→y) from x to y in G such that none of the intermediate nodes xᵢ (if any) is in parents(x).

The Markov condition associated with an LCN [symbol] allows additional independence assumptions to be made between its atoms. Namely, given a model M of [symbol] , every atom x in [symbol] is conditional independent of its non-descendant non-parent atoms given its parents in [symbol] 's primal graph.

For example, the following propositional LCN can be considered. The sentences below state that: burglaries (b) are more common than earthquakes (e) (Eq. 3 and 4); the house alarm (a) can be triggered by a burglary or an earthquake (Eq. 5); in case of an alarm, either both Charles (c) and Dan (d) call the emergency services or neither does (Eq. 6); the alarm can also be triggered accidentally (Eq. 7).

$$0.1 \leq P ( b ) \leq 0.2 \qquad ( 3 )$$

$$0.05 P ( e ) \leq 0.1 \qquad ( 4 )$$

$$0.8 \leq P ( a \vert b ∨ e ) \leq 0.9 \qquad ( 5 )$$

$$0.7 \leq P ( ¬ ( c ⊕ d ) \vert a ) \leq 0.8 \qquad ( 6 )$$

$$0.01 \leq P ( a ) \leq 0 \text{.08} . \qquad ( 7 )$$

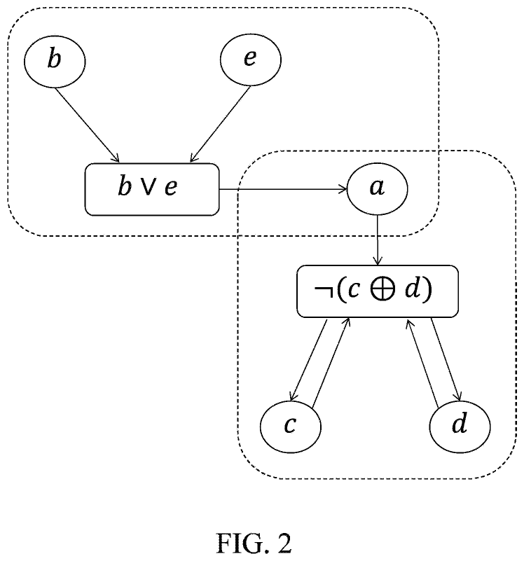

FIG. 2 depicts a factor graph of the LCN where the round nodes represent atomic nodes and the rectangular nodes correspond to the formula nodes, respectively. In this case, it can be assumed that the t flag associated with the sentences is True. Therefore, b and e are independent, c is conditionally independent of {b, e} given {a, d}, and d is conditionally independent of {b, e} given {a, c}.

Given an LCN [symbol] and a query formula ρ, the marginal inference task computes lower and upper bounds on the posterior marginal probability P(ρ), denoted by P(ρ) and P(ρ), respectively. The task entails solving a non-linear program defined over a set of variables representing the probabilities of [symbol] 's interpretations and including linear constraints derived from [symbol] 's sentences, non-linear constraints corresponding to the independence assumptions derived from [symbol] 's Markov condition and a linear objective function corresponding to the query P(ρ) which is subsequently minimized and maximized to yield the desired bounds.

Given [symbol] =(p₁, . . . , p_{N}) as the vector representing the probabilities of the N=2ⁿ interpretations of an LCN [symbol] with n atoms, and given [symbol] _{α}=(a₁^{α}, . . . , a_{N}^{α}) as a binary vector, called an indicator vector, such that aⱼ^{α} is 1 if formula α is true in the j-th interpretation and 0 otherwise. Since the probability of a formula α is the sum of the probabilities of the interpretations in which α is true, it can be written P(α) as [symbol] _{α}⊙ [symbol] where ⊙ is the dot-product of two vectors. Therefore, the following equations can be solved, where

$${\sum }_{i = 1}^{N} {p}_{i} = 1 \qquad ( 8 )$$

$${p}_{i} \geq 0 , ∀ i = 1 , … , N \qquad ( 9 )$$

$${1}_{q} \leq {\vec{A}}_{p} ⊙ \vec{p} \leq {u}_{q} \qquad ( 10 )$$

$${1}_{q \vert r} \cdot {\vec{A}}_{r} ⊙ \vec{p} \leq {\vec{A}}_{q ⋀ r} ⊙ \vec{p} \leq {u}_{q \vert r} \cdot {\vec{A}}_{r} ⊙ \vec{p} \qquad ( 11 )$$

$$( {\vec{A}}_{α} ⊙ \vec{p} ) \cdot ( {\vec{A}}_{β} ⊙ \vec{p} ) - ( {\vec{A}}_{γ} ⊙ \vec{p} ) \cdot ( {\vec{A}}_{δ} \cdot \vec{p} ) = 0 \qquad ( 12 )$$

$$minimize / maximize {\vec{A}}_{p} ⊙ \vec{p}$$

where xᵢ is an atomic formula, Sᵢ={sᵢ₁, . . . , sᵢₖ} and Tᵢ={tᵢ₁, . . . , tᵢₗ} are xᵢ's parents and non-descendants in the primal graph, [symbol] _{g} and [symbol] _{q∧r} are the indicator vectors for formulas q and q∧r, and [symbol] _{α}, [symbol] _{β}, [symbol] _{γ}, and [symbol] _{δ} are the indicator vectors corresponding to the formulas α=(xᵢ∧sᵢ₁∧ . . . ∧sᵢₖ∧tᵢ₁∧ . . . ∧tᵢₗ), β=(sᵢ₁∧ . . . ∧sᵢₖ), γ=(xᵢ∧sᵢ₁∧ . . . ∧sᵢₖ), and δ=(sᵢ₁∧ . . . ∧sᵢₖ∧tᵢ₁∧ . . . ∧tᵢₗ). Equations (8) and (9) ensure that [symbol] _{q∧r} is a valid probability distribution, while Equations (10) and (11) encode the sentences of type (1) and (2) in L. Equation 12 encodes the conditional independencies implied by the Markov condition, i.e., P(xᵢ|Sᵢ, Tᵢ)=P(xᵢ|Sᵢ), which must hold for all truth values of its atoms.

### Approximate Inference in LCNs

Since exact inference is not tractable for large LCNs, aspects of the present disclosure introduce a new message-passing algorithm to approximate the posterior marginals of the atomic formulas in an LCN. The basic idea is to follow the classical belief propagation scheme on a factor graph associated with the LCN and propagate messages between the variable and factor nodes until convergence.

A. Incompatibility with Belief Propagation

Graphical models such as Bayesian networks or credal networks typically require a unique assessment assumption, namely a variable must occur in either a marginal distribution (credal set) or a conditional distribution (conditional credal set) but not both, and for each conditional distribution or credal set, all possible interpretations of the parent variables must be specified. LCNs do not require the unique-assessment assumption and, therefore, the sum-product message-passing based approximate inference methods (i.e., belief propagation) which were originally developed for credal networks (i.e., 2U, L2U, or IPE) are not compatible with LCNs. The following illustrative example can be considered, where

$$0.2 \leq P ( a ) \leq 0.3 \qquad ( 13 )$$

$$0.6 \leq P ( b \vert a ) \leq 0.7 \qquad ( 14 )$$

$$0.1 \leq P ( b \vert ¬ a ) \leq 0.2 \qquad ( 15 )$$

$$0.3 \leq P ( b ) \leq 0.4 . \qquad ( 16 )$$

Clearly, this is not a valid credal network because sentence (16) violates the unique-assessment assumption but is legitimate for an LCN. If P (b) is queried, the correct answer is [0.3, 0.35]. However, 2U or L2U yield an incorrect answer of [0.1, 0.26] even though the underlying graph has a tree-like structure.

### B. Message-Passing Scheme

A definition of the factor graph associated with an LCN that underlies our message-passing scheme is provided as Definition 3.1 (factor graph), where, given an LCN [symbol] , the factor graph F of [symbol] is a bipartite graph with variable nodes and factor nodes, respectively. A variable node corresponds to an atom in [symbol] , while a factor node represents one or more sentences in [symbol] that involve the same set of atoms. A factor node is connected to a variable node if they share the same atom.

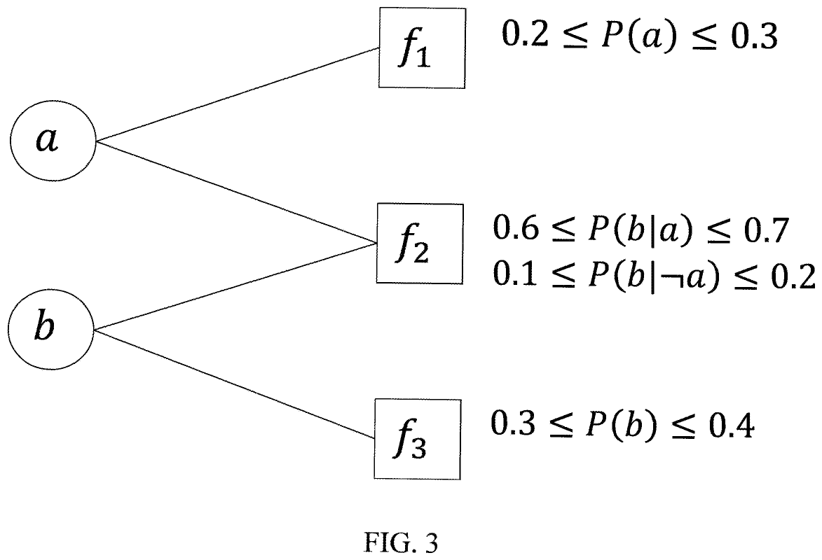

For example, FIG. 3 shows the factor graph associated with the LCN given by sentences (13)-(16). There are 2 variable nodes (depicted as circles) corresponding to atoms {a, b} and 3 factor nodes (depicted as squares) f₁, f₂ and f₃ corresponding to sentences (13), (14), (15), and (16), respectively.

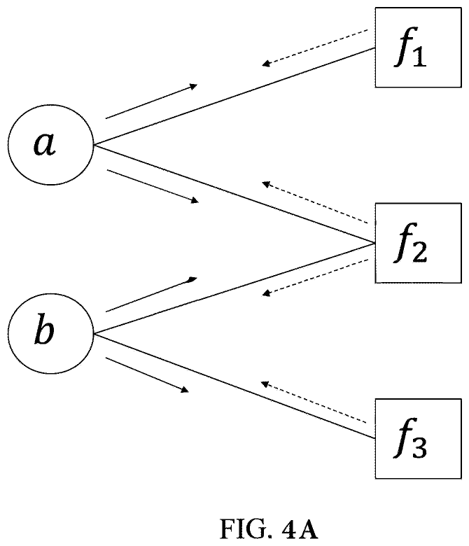

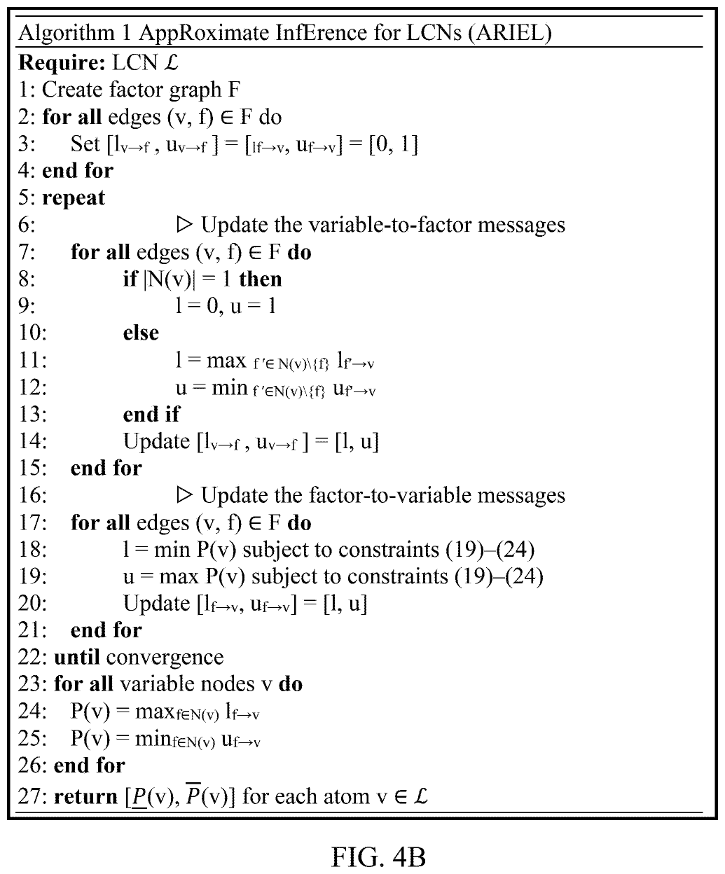

Given a factor graph F, the high-level flow of the message-passing scheme, according to embodiments of the present disclosure, is similar to that of classical belief propagation, namely to iteratively pass and update messages between the variable and factor nodes of F until convergence. Let v and f denote a variable node and a factor node in F, respectively. N(⋅) can be used to denote the neighbors of a node in F. Two kinds of messages will be propagated along the edges of F, as follows: (1) The variable-to-factor message (solid arrow in FIG. 4A). The message sent by a variable node v to a neighboring factor node f is an interval [l_{v→f}, u_{v→f}], where 0≤l_{v→f}≤u_{v→f}≤1. If node v has only one neighbor, then the message [l_{v→f}, u_{v→f}] is just [0, 1]. Otherwise, the message [l_{v→f}, u_{v→f}] is defined by:

$${l}_{v \to f} = {max}_{{f}^{′} ∈ N ( v ) \{ f \}} {l}_{{f}^{′} \to v} \qquad ( 17 )$$

$${u}_{v \to f} = {max}_{{f}^{′} ∈ N ( v ) \{ f \}} {u}_{{f}^{′} \to v} \qquad ( 18 )$$

where [l_{f′→v}, u_{f′→v}] is the message sent by a neighboring factor node f′∈N(v)\{f}, other than f, to v. (2) The factor-to-variable message (dashed arrow in FIG. 4A). The message sent by a factor node f to a neighboring variable node v is also an interval [l_{f→v}, u_{f→v}] obtained by minimizing and, respectively, maximizing the objective function P(v) subject to (i) a set of linear constraints encoding f's sentences, (ii) a set of linear constraints ensuring that, for each variable node other than v that is connected to f, its marginal probability is within the bounds given by the corresponding variable-to-factor messages, namely l_{v′→f}≤P(v′)≤u_{v′→f}, ∀v′∈N(f)\{v}, and (iii) a set of non-linear constraints encoding the assumption that f's atoms (other than v) are independent of each other. The latter independence assumption in the local constraint program is a mechanism to approximate the Markov condition, and the same approach is used in classical belief propagation.

Specifically, if f involves at most k atoms, namely N(f)={v₁, . . . , vₖ}, then the message [l_{f→v}, u_{f→v}] is computed by solving the following local constraint program:

$${\sum }_{i = 1}^{K} {p}_{i} = 1 \qquad ( 19 )$$

$${p}_{i} \geq 0 , {∀}_{i} = 1 , … , K \qquad ( 20 )$$

$${1}_{q} \leq \vec{{A}_{q}} \cdot \vec{p} \leq {u}_{q} \qquad ( 21 )$$

$${l}_{q \vert r} \vec{{A}_{r}} ⊙ \vec{p} \leq {\vec{A}}_{q ⋀ r} ⊙ \vec{p} \leq {u}_{q \vert r} \vec{{A}_{r -}} ⊙ \vec{p} \qquad ( 22 )$$

$${l}_{{v}^{′} \to f} \leq {\vec{A}}_{{v}^{′}} ⊙ \vec{p} \leq {u}_{{v}^{′} \to f} , ∀ {v}^{′} ∈ {N}_{f} \qquad ( 23 )$$

$${\vec{A}}_{{v}^{′} ⋀ {v}^{″}} ⊙ \vec{p} = ( {\vec{A}}_{{v}^{′}} ⊙ \vec{p} ) \cdot ( {\vec{A}}_{{v}^{″}} ⊙ \vec{p} ) , ∀ {v}^{′} \neq {v}^{″} ∈ {N}_{f} \qquad ( 24 )$$

$$minimize / maximize {\vec{A}}_{v} ⊙ \vec{p}$$

where [symbol] =(p₁, . . . , p_{K}) is the vector representing the probabilities of the K=2k interpretations, N_{f}=N(f)\{v} denotes f's neighbors other than v and [l_{v′→f}, u_{v′→f}] is the message sent by a neighboring variable node v′∈N_{f} to f, respectively. Sentences (21) and (22) encode sentences of type (1) and (2) in f, Sentence (23) ensures that v's marginal probability is within the required bounds, while Sentence (24) encodes the independence assumption between f's atoms.

For example, the LCN defined by the following sentence can be considered, 0.3≤P (c∧(d∨e))≤0.4. The factor graph has one factor node f corresponding to the sentence and three variable nodes for the atoms {c, d, e}, respectively. The factor-to-variable message [l_{f→d}, u_{f→d}] is obtained by minimizing and maximizing the following non-linear program:

$$\begin{matrix}0.3 \leq P ( c ⋀ ( d ⋁ e ) ) \leq 0.4 \\ {l}_{c \to f} \leq P ( c ) \leq {u}_{c \to f} \\ {l}_{e \to f} \leq P ( c ) \leq {u}_{e \to f} \\ P ( c ⋀ e ) = P ( c ) \cdot P ( e ) \\ minimize / maximize P ( d ) .\end{matrix}$$

Algorithm 1, provided in FIG. 4B, referred to as “ARIEL” summarizes the message-passing scheme for approximate inference in LCNs. All messages along the edges of the factor graph are first initialized with [0, 1] intervals. Subsequently, the variable-to-factor and factor-to-variable messages are updated in an iterative manner until convergence (i.e., either a fixed number of iterations is exceeded or the average change in messages from one iteration to the next is below a given threshold). Finally, for each variable node v, the lower and upper bounds of the posterior marginal interval are obtained by maximizing and, respectively, minimizing the lower and upper bounds of the incoming factor-to-variable messages to v (lines 16-18), namely:

$$\underline{P} ( v ) = {max}_{f ∈ N ( ) v} {l}_{f \to v} and \overline{P} ( v ) = {max}_{f ∈ N ( v )} {u}_{f \to v}$$

For example, continuing the exemplary LCN defined by Sentences (13)-(16), above, the message [l_{f2→b}, u_{f2→b}] is obtained by solving:

$$\begin{matrix}0.6 \leq P ( b \vert a ) \leq 0.7 \\ 0.1 \leq P ( b \vert ¬ a ) \leq 0.2 \\ {l}_{a \to f 2} \leq P ( a ) \leq {u}_{a \to f 2} \\ minimize / maximize P ( b ) .\end{matrix}$$

The following messages are obtained upon convergence:

$$\begin{matrix}{l}_{f 1 \to a} = 0.2 , {u}_{f 1 \to a} = 0.3 \\ {l}_{a \to f 1} = 0.2 , {u}_{a \to f 1} = 0.6 \\ {l}_{a \to f 2} = 0.2 , {u}_{a \to f 2} = 0.3 \\ {l}_{f 2 \to a} = 0.2 , {u}_{f 2 \to a} = 0.6 \\ {l}_{f 2 \to b} = 0.2 , {u}_{f 2 \to b} = 0.35 \\ {l}_{b \to f 2} = 0.3 , {u}_{b \to f 2} = 0.4 \\ {l}_{b \to f 3} = 0.2 , {u}_{b \to f 3} = 0.35 \\ {l}_{f 3 \to b} = 0.3 , {u}_{f 3 \to b} = 0.4 .\end{matrix}$$

Finally, the lower and upper bounds for P (b) are given by:

$$\begin{matrix}\underline{P} ( b ) = max ( {l}_{f 2 \to b} , {l}_{f3 \to b} ) = max ( 0.2 , 0.3 ) = 0.3 \\ \overline{P} ( b ) = min ( {u}_{f 2 \to b} , {u}_{f3 \to b} ) = min ( 0.35 , 0.4 ) = 0.35 ,\end{matrix}$$

which match the results of exact inference in this case.

### C. Properties

Next, it is shown that ARIEL computes exact posterior marginal probability intervals for singly-connected LCNs. Definition 3.2 refers to letting [symbol] be an LCN with primal graph G. The LCN [symbol] can be called singly-connected if G does not contain directed cycles.

Theorem 1 (correctness) is defined as follows. Given a singly-connected LCN with n atoms denoted by V={v₁, . . . , vₙ}, ARIEL computes exact posterior marginal lower and upper bounds P(vᵢ) and P̅(vᵢ), for each atom vᵢ∈V. It should be noted that Theorem 1 holds even if the LCN contains additional marginal probability sentences that break the unique assessment assumption. However, in general, LCNs may contain directed cycles and, in this case, there is no guarantee on correctness. This is also true for the classical loopy belief propagation algorithms in probabilistic graphical models.

Theorem 2 (complexity) is defined as follows. Let [symbol] be an LCN such that its factor graph has n variable nodes (atoms) and m factor nodes. Assuming a fixed number of iterations i, the complexity of Algorithm 1 is O(i·n·m·Q), where Q bounds the complexity of solving the local non-linear programs at factor nodes. Each of these non-linear programs involves 2^{t} variables, where t bounds the number of atoms in a factor node.

D. Comparison with Other Algorithms

The bound tightening operation at variable nodes is conceptually similar to a recent inference algorithm for logical neural networks. The message computation at factor nodes bears some similarity to the 2U and L2U algorithms for credal networks, which make similar independence assumption to approximate the Markov condition. ARIEL is also related with the IPE algorithm for credal networks which selects the tightest bounds over a number of polytree subgraphs.

### E. Handling Complex Query Formulas

Let ρ be a non-atomic query formula and let {v₁, . . . , vₖ} be its atoms. In this case, following the message propagation outlined by Algorithm 1, the marginal P(φ can be approximated by solving the non-linear constraint program:

$${\sum }_{i = 1}^{K} {p}_{i} = 1 \qquad ( 25 )$$

$${p}_{i} \geq 0 , {∀}_{i} = 1 , … , K \qquad ( 26 )$$

$${l}_{{v}^{′} \to f} \leq {\vec{A}}_{{v}^{′}} ⊙ \vec{p} \leq {u}_{{v}^{′} \to f} , ∀ {v}^{′} ∈ N ( {f}^{′} ) \qquad ( 27 )$$

$${\vec{A}}_{{v}^{′} ⋀ {v}^{″}} ⊙ \vec{p} = ( {\vec{A}}_{{v}^{′}} ⊙ \vec{p} ) \cdot ( {\vec{A}}_{{v}^{″}} ⊙ \vec{p} ) , ∀ {v}^{′} \neq {v}^{″} ∈ N ( {f}^{′} ) \qquad ( 28 )$$

$$minimize / maximize {\vec{A}}_{p} ⊙ \vec{p} ,$$

where f′ is an auxiliary factor node corresponding to ρ, N(f′)={v₁, . . . , vₖ} and [symbol] ₚ is p's indicator vector.

### Experiments

The ARIEL scheme was evaluated empirically for approximate inference and compare it with exact inference on several classes of LCNs. The competing algorithms were implemented in Python 3.8 and used the ipopt 3.12 solver with default settings to handle the non-linear constraint programs. All experiments were run on a 2.2 GHz Intel Core processor with 32 GB of RAM.

Measure of Performance. In all experiments the average CPU time in seconds was reported, as well as the mean absolute error (MAE) for the posterior marginal lower and upper bounds obtained for each propositional variable. More specifically, for each problem instance, the errors were defined as:

$$\begin{matrix}{MAE}_{l} = \frac{1}{n} {\sum }_{i = 1}^{n} \vert \underline{{P}^{*}} ( {x}_{i} ) - \underline{P} ( {x}_{i} ) \vert \\ {MAE}_{n} = \frac{1}{n} {\sum }_{i = 1}^{n} \vert \overline{{P}^{*}} ( {x}_{i} ) - \overline{P} ( {x}_{i} ) \vert\end{matrix}$$

where n is the number of variables, |P*(xᵢ) and P̅*̅(xᵢ) are the exact posterior marginal lower bounds on P(xᵢ) for each variable xᵢ, while P(xᵢ) and P̅(xᵢ) are the approximate marginal bounds computed by ARIEL.

### A. Random LCNs

Several classes of random LCNs were generated with n propositional variables {x₁, . . . , xₙ}, called polytree, dag, and random, respectively, having m sentences of the following types:

$$1 \leq P ( {x}_{i} ) \leq u \qquad ( a )$$

$$1 \leq P ( {x}_{i} \vert {x}_{j} ) \leq u , {x}_{i} \neq {x}_{j} \qquad ( b )$$

$$1 \leq P ( {x}_{i} \vert {x}_{j} ⋀ {x}_{k} ) \leq u {x}_{i} \neq {x}_{j} \neq {x}_{k} . \qquad ( c )$$

Specifically, for polytree LCNs, there are m=n sentences of types (a), (b), and (c) generated randomly such that the corresponding primal graph is a polytree (i.e., there are no directed cycles). The dag instances contain m=n randomly generated sentences of types (a), (b), and (c) such that the primal graph is a directed acyclic graph (DAG). For random LCNs there were m=n sentences of types (a), (b), and (c) generated randomly without the acyclicity requirement. In all cases, e additional sentences were added of type (a).

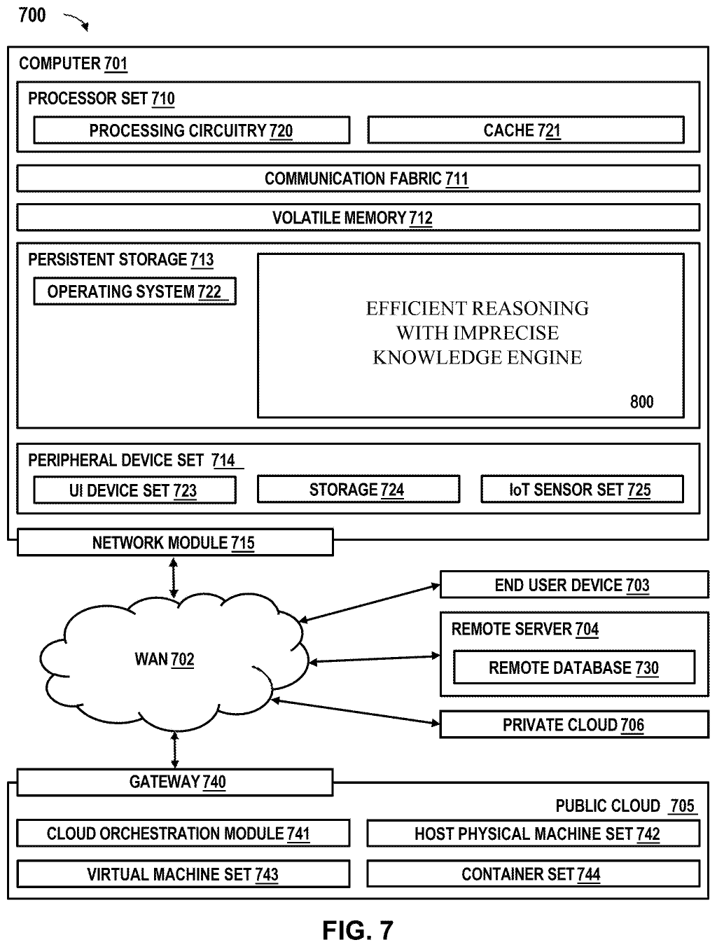

It should be noted that, for type (a), only one sentence P(xᵢ) was generated while for types (b) and (c) sentences were generated for all truth values of xⱼ and xₖ, namely P(xᵢ|xⱼ), P(xᵢ|¬xⱼ), P(xᵢ|xⱼ∧xₖ), P(xᵢ|xⱼ∧¬xₖ), P(xᵢ|¬xⱼ∧xₖ), and P(xᵢ|¬xⱼ∧¬xₖ), respectively. The probability bounds l and u of the sentences were selected uniformly at random between 0 and 1 such that u−l≤0.6. Furthermore, it was ensured that all problem instances generated were consistent. Table 1, provided as FIG. 8, summarizes the results obtained on polytree, dag and random instances of varying sizes with n∈{5, 6, . . . , 10} and e=2. Each data point in the table represents an average over 10 random instances generated for that particular problem size. The second and third columns report the running times of the conventional, exact method and the approximate inference algorithms of the present disclosure, while the fourth and fifth columns give the errors MAEₗ and MAEᵤ on the posterior marginal bounds computed by ARIEL using a maximum of 10 iterations and a 10⁻⁶ threshold for convergence (whichever comes first).

When looking at the solution quality, especially on the polytree problems, it can be seen that the absolute errors are very small (close to zero), thus verifying the correctness of ARIEL on singly-connected LCNs (the discrepancies are caused by the numerical precision for representing real numbers as well as the default tolerances used by the ipopt solver). For dag and random problems, the errors are also small and suggest that the approximate posterior marginals are fairly close to the exact ones. In terms of running time, it can be seen that, as expected, ARIEL scales much better to larger problems compared with the conventional (exact) algorithm. For example, on dag and random problems of size 10, the algorithm of the present disclosure is already almost 4 orders of magnitude faster while producing relatively good quality solutions.

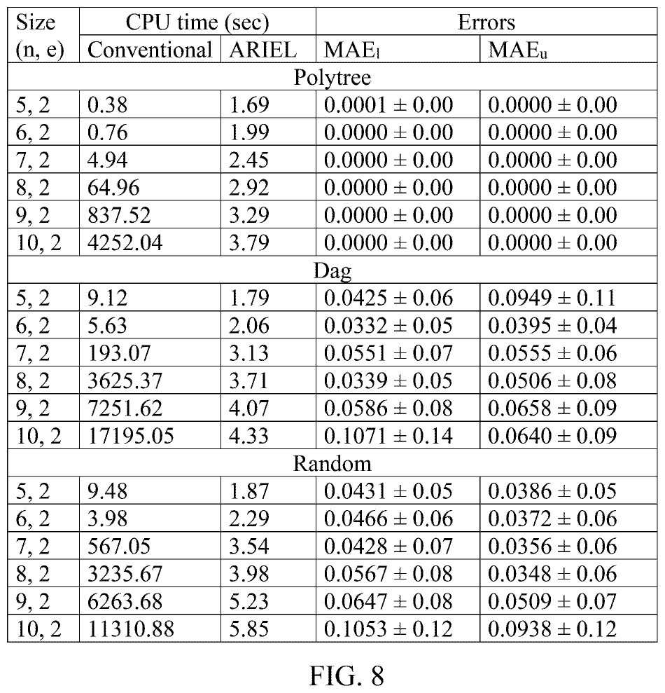

Furthermore, Table 2, provided as FIG. 9, reports results obtained on much larger random LCNs with up to 100,000 propositional variables. It can be seen that ARIEL was able to solve all these problem instances while the conventional (exact) algorithm could not go beyond the smallest problem size. Specifically, the conventional algorithm exceeded the 30 hour time limit for the n=100 case and ran out of memory while building the non-linear program for n>1000, respectively. This demonstrates clearly that ARIEL overcomes the major limitation of exact inference for LCNs and thus provides the ability to tackle efficiently much larger problems possibly involving many thousands of variables.

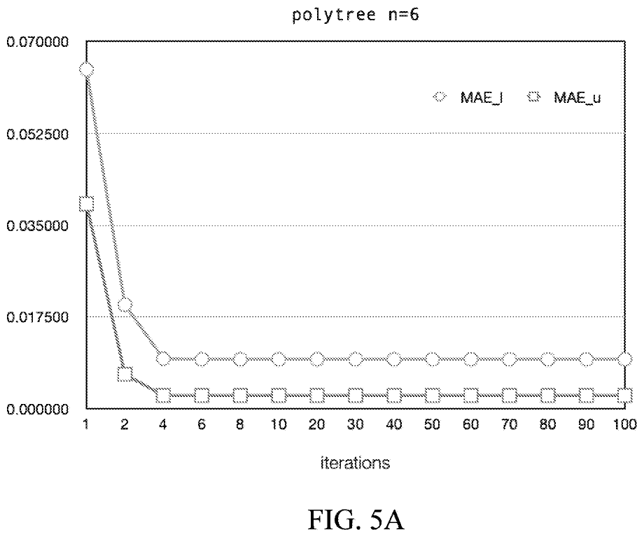

In FIGS. 5A and 5B, the mean absolute errors MAEₗ and MAEᵤ are plotted as a function of the number of iterations used by ARIEL for solving the polytree and dag benchmarks of size n=6, respectively. ARIEL's convergence threshold was set to 0. It can be seen that the algorithm is able to converge to relatively small errors after less than 10 iterations. A similar pattern was also observed on the other benchmarks.

### B. Real-World LCNs

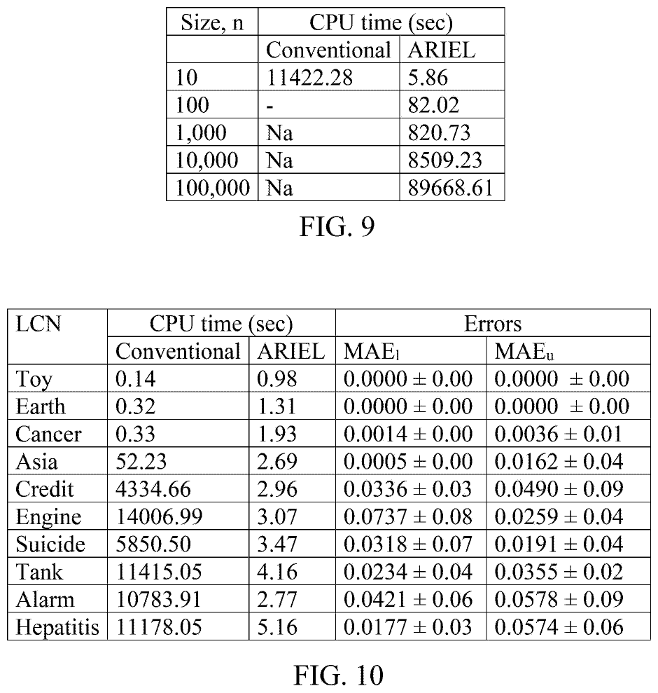

Table 3, provided as FIG. 10, displays the results obtained on LCNs derived from real-world Bayesian networks with binary variables. More specifically, each of these LCNs contains sentences of the form l≤P(xᵢ)≤u and l≤P(xᵢ|πᵢ)≤u, respectively, where xᵢ is a variable and πᵢ=yᵢ₁∧ . . . ∧yᵢₖ is the conjunction of the propositional variables corresponding to a particular configuration of the parents {yᵢ₁, . . . yᵢₖ} of xᵢ in the Bayesian network. The bounds l and u were selected such that u−l≤0.4, while the numbers of variables and sentences ranged between 4 and 10, and between 6 and 24, respectively.

It can be seen again that ARIEL outperformed dramatically the conventional inference method in terms of running time while maintaining a relatively good solution quality. For example, on the Tank and Hepatitis problem instances, ARIEL is almost 4 orders of magnitude faster than its competitor, while the corresponding posterior bounds start to differ at the second decimal point compared with the exact ones.

### C. Application to Chemistry

Another possible application of LCNs and approximate inference is in the chemistry domain. Specifically, a binary molecular classification task was considered using imprecise expert knowledge as well as molecular fingerprinting data. In this case, the class variable is denoted by y∈{0, 1} while the molecule structure is represented by a set of n binary features (or fingerprints) F={f₁, . . . , fₙ} indicating the presence or absence of certain molecular substructures. The LCN is defined by the following types of sentences: (a) 10≤P(¬y)≤u₀ and l₁≤P(y)≤u₁ representing the class probability, (b) lᵢ₀≤P(fᵢ|¬y)≤uᵢ₀ and lᵢ₁≤P(fᵢ|y)≤uᵢ₁ representing the conditional probability of feature fᵢ∈F being present given the class, and (c) l≤P(y|F(fᵢ₁, fᵢ₂, . . . , fᵢₖ))≤u and l≤P(¬y|F(fᵢ₁, fᵢ₂, . . . , fᵢₖ))≤u, where {fᵢ₁, . . . , fᵢₖ} is a subset of features and F(fᵢ₁, . . . , fᵢₖ) is the conjunction of their respective values, respectively (e.g., F(f₁, f₂)=f₁∧¬f₂). The latter represents imprecise knowledge from one or more domain experts stating that the class can be determined by specific combinations of features.

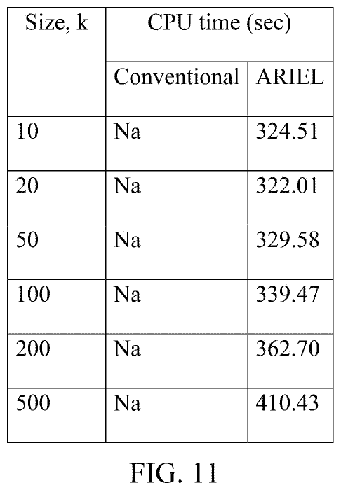

Given a new molecule for which only a subset of features {f₁, . . . , fₖ} is observed, the task is to compute the posterior marginal probability of its class, namely P(y|f₁, . . . , fₖ) and P(¬y|f₁, . . . , fₖ). A database containing 1298 molecules with n=985 features was considered. The corresponding LCN has 986 propositional variables, 2 sentences of type (a), 985 sentences of type (b) and 6 sentences of type (c), respectively. The observed features are translated into k additional constraints of the form P(fⱼ)=1.0 or P(¬fⱼ)=1.0 ∀j=1 . . . k, depending on whether fⱼ is absent or present. Table 4, provided as FIG. 11, summarizes the results obtained for different sizes of the observed feature subset. Specifically, for each value of k, 10 configurations of k features were generated, selected uniformly at random from F and the average running time was reported. As before, it can be seen that ARIEL was able to solve all problem instances in a little over 5 minutes on average, while the conventional method ran out of memory in all test cases.

In summary, it can be concluded that the approximate inference algorithm ARIEL, according to the present disclosure, is the only inference scheme that can tackle practical larger scale LCNs.

### Example Process

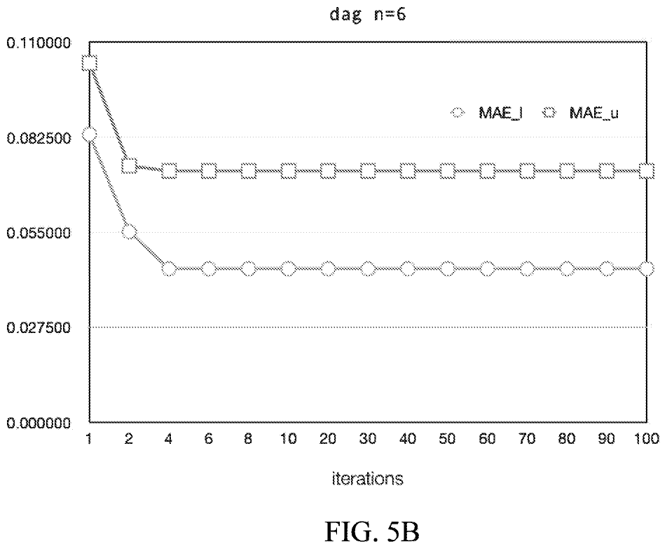

It may be helpful now to consider a high-level discussion of an example process. To that end, FIG. 6 presents an illustrative process 600 related to the method for reasoning using imprecise knowledge. Process 600 is illustrated as a collection of blocks, in a logical flowchart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. In each process, the order in which the operations are described is not intended to be construed as a limitation, and any number of the described blocks can be combined in any order and/or performed in parallel to implement the process.

Referring to FIG. 6, block 602 of process 600, can include an act of receiving input. The input can include a set of logic formulas, a set of intervals representing lower and upper bounds on the truth values of the formulas in the set of logic formulas, and a query formula. At block 604, at act of converting the logic formulas, from the input, into a logical credal network (LCN) representation can be performed. At block 606, a factor graph representation of the LCN representation can be created. Finally, at block 608, a probability interval [l, u] can be provided as output, such that l≤P(q)≤u, where P(q) represents a query for a given probability interval.

### Example Computing Platform

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

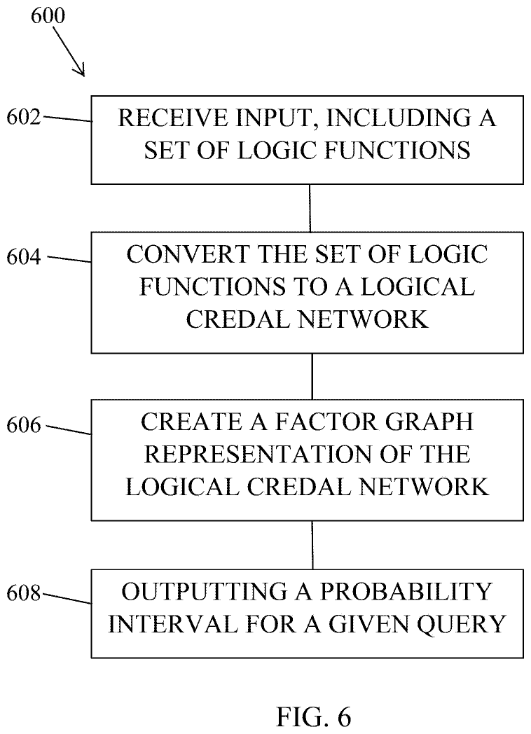

Referring to FIG. 7, computing environment 700 includes an example of an environment for the execution of at least some of the computer code involved in performing the inventive methods, including an efficient reasoning with imprecise knowledge engine block 800. In addition to block 800, computing environment 700 includes, for example, computer 701, wide area network (WAN) 702, end user device (EUD) 703, remote server 704, public cloud 705, and private cloud 706. In this embodiment, computer 701 includes processor set 710 (including processing circuitry 720 and cache 721), communication fabric 711, volatile memory 712, persistent storage 713 (including operating system 722 and block 500, as identified above), peripheral device set 714 (including user interface (UI) device set 723, storage 724, and Internet of Things (IoT) sensor set 725), and network module 715. Remote server 704 includes remote database 730. Public cloud 705 includes gateway 740, cloud orchestration module 741, host physical machine set 742, virtual machine set 743, and container set 744.

COMPUTER 701 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 730. As is well understood in the art of computer technology, and depending upon the technology, performance of a computer-implemented method may be distributed among multiple computers and/or between multiple locations. On the other hand, in this presentation of computing environment 700, detailed discussion is focused on a single computer, specifically computer 701, to keep the presentation as simple as possible. Computer 701 may be located in a cloud, even though it is not shown in a cloud in FIG. 7. On the other hand, computer 701 is not required to be in a cloud except to any extent as may be affirmatively indicated.

PROCESSOR SET 710 includes one, or more, computer processors of any type now known or to be developed in the future. Processing circuitry 720 may be distributed over multiple packages, for example, multiple, coordinated integrated circuit chips. Processing circuitry 720 may implement multiple processor threads and/or multiple processor cores. Cache 721 is memory that is located in the processor chip package(s) and is typically used for data or code that should be available for rapid access by the threads or cores running on processor set 710. Cache memories are typically organized into multiple levels depending upon relative proximity to the processing circuitry. Alternatively, some, or all, of the cache for the processor set may be located “off chip.” In some computing environments, processor set 710 may be designed for working with qubits and performing quantum computing.

Computer readable program instructions are typically loaded onto computer 701 to cause a series of operational steps to be performed by processor set 710 of computer 701 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 721 and the other storage media discussed below. The program instructions, and associated data, are accessed by processor set 710 to control and direct performance of the inventive methods. In computing environment 700, at least some of the instructions for performing the inventive methods may be stored in block 500 in persistent storage 713.

COMMUNICATION FABRIC 711 is the signal conduction path that allows the various components of computer 701 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 712 is any type of volatile memory now known or to be developed in the future. Examples include dynamic type random access memory (RAM) or static type RAM. Typically, volatile memory 712 is characterized by random access, but this is not required unless affirmatively indicated. In computer 701, the volatile memory 712 is located in a single package and is internal to computer 701, but, alternatively or additionally, the volatile memory may be distributed over multiple packages and/or located externally with respect to computer 701.

PERSISTENT STORAGE 713 is any form of non-volatile storage for computers that is now known or to be developed in the future. The non-volatility of this storage means that the stored data is maintained regardless of whether power is being supplied to computer 701 and/or directly to persistent storage 713. Persistent storage 713 may be a read only memory (ROM), but typically at least a portion of the persistent storage allows writing of data, deletion of data and re-writing of data. Some familiar forms of persistent storage include magnetic disks and solid state storage devices. Operating system 722 may take several forms, such as various known proprietary operating systems or open source Portable Operating System Interface-type operating systems that employ a kernel. The code included in block 500 typically includes at least some of the computer code involved in performing the inventive methods.

PERIPHERAL DEVICE SET 714 includes the set of peripheral devices of computer 701. Data communication connections between the peripheral devices and the other components of computer 701 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 723 may include components such as a display screen, speaker, microphone, wearable devices (such as goggles and smart watches), keyboard, mouse, printer, touchpad, game controllers, and haptic devices. Storage 724 is external storage, such as an external hard drive, or insertable storage, such as an SD card. Storage 724 may be persistent and/or volatile. In some embodiments, storage 724 may take the form of a quantum computing storage device for storing data in the form of qubits. In embodiments where computer 701 is required to have a large amount of storage (for example, where computer 701 locally stores and manages a large database) then this storage may be provided by peripheral storage devices designed for storing very large amounts of data, such as a storage area network (SAN) that is shared by multiple, geographically distributed computers. IoT sensor set 725 is made up of sensors that can be used in Internet of Things applications. For example, one sensor may be a thermometer and another sensor may be a motion detector.

NETWORK MODULE 715 is the collection of computer software, hardware, and firmware that allows computer 701 to communicate with other computers through WAN 702. Network module 715 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 715 are performed on the same physical hardware device. In other embodiments (for example, embodiments that utilize software-defined networking (SDN)), the control functions and the forwarding functions of network module 715 are performed on physically separate devices, such that the control functions manage several different network hardware devices. Computer readable program instructions for performing the inventive methods can typically be downloaded to computer 701 from an external computer or external storage device through a network adapter card or network interface included in network module 715.

WAN 702 is any wide area network (for example, the internet) capable of communicating computer data over non-local distances by any technology for communicating computer data, now known or to be developed in the future. In some embodiments, the WAN 702 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 703 is any computer system that is used and controlled by an end user (for example, a customer of an enterprise that operates computer 701), and may take any of the forms discussed above in connection with computer 701. EUD 703 typically receives helpful and useful data from the operations of computer 701. For example, in a hypothetical case where computer 701 is designed to provide a recommendation to an end user, this recommendation would typically be communicated from network module 715 of computer 701 through WAN 702 to EUD 703. In this way, EUD 703 can display, or otherwise present, the recommendation to an end user. In some embodiments, EUD 703 may be a client device, such as thin client, heavy client, mainframe computer, desktop computer and so on.

REMOTE SERVER 704 is any computer system that serves at least some data and/or functionality to computer 701. Remote server 704 may be controlled and used by the same entity that operates computer 701. Remote server 704 represents the machine(s) that collect and store helpful and useful data for use by other computers, such as computer 701. For example, in a hypothetical case where computer 701 is designed and programmed to provide a recommendation based on historical data, then this historical data may be provided to computer 701 from remote database 730 of remote server 704.

PUBLIC CLOUD 705 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 705 is performed by the computer hardware and/or software of cloud orchestration module 741. The computing resources provided by public cloud 705 are typically implemented by virtual computing environments that run on various computers making up the computers of host physical machine set 742, which is the universe of physical computers in and/or available to public cloud 705. The virtual computing environments (VCEs) typically take the form of virtual machines from virtual machine set 743 and/or containers from container set 744. It is understood that these VCEs may be stored as images and may be transferred among and between the various physical machine hosts, either as images or after instantiation of the VCE. Cloud orchestration module 741 manages the transfer and storage of images, deploys new instantiations of VCEs and manages active instantiations of VCE deployments. Gateway 740 is the collection of computer software, hardware, and firmware that allows public cloud 705 to communicate through WAN 702.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 706 is similar to public cloud 705, except that the computing resources are only available for use by a single enterprise. While private cloud 706 is depicted as being in communication with WAN 702, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 705 and private cloud 706 are both part of a larger hybrid cloud.

### CONCLUSION

The descriptions of the various embodiments of the present teachings have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications, and variations that fall within the true scope of the present teachings.

The components, steps, features, objects, benefits, and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Aspects of the present disclosure are described herein with reference to a flowchart illustration and/or block diagram of a method, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of an appropriately configured computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The call-flow, flowchart, and block diagrams in the figures herein illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, the inventive subject matter lies in less than all features of a single disclosed embodiment. Thus, the following claims are hereby incorporated into the Detailed Description, with each claim standing on its own as a separately claimed subject matter.

What is claimed is:

1. A computer-implemented method for facilitating reasoning under conditions of uncertainty, comprising:
receiving input including a set of logic formulas, a set of intervals representing lower and upper bounds on truth values of formulas in the set of logic formulas, and a query formula;
converting the logic formulas into a logical credal network (LCN) representation;
creating a factor graph representation of the LCN representation; and
outputting a probability interval [l, u] of P(q), where P(q) represents a query for a given probability interval.

2. The computer-implemented method of claim 1, further comprising computing node-to-factor and factor-to-node messages in the factor graph representation.

3. The computer-implemented method of claim 2, wherein the node-to-factor and factor-to-node messages between nodes of the factor graph representation are lower and upper bounds on marginal probabilities.

4. The computer-implemented method of claim 2, further comprising solving a quadratic program encoding of the node-to-factor and factor-to-node messages and the query formula to obtain l≤P(q)≤u.

5. The computer implemented method of claim 4, wherein the quadratic program is:
$${\sum }_{i = 1}^{K} {p}_{i} = 1 ,$$
$${p}_{i} \geq 0 , {∀}_{i} = 1 , … , K ,$$
$${l}_{{v}^{′} \to f} \leq {\vec{A}}_{{v}^{′}} ⊙ \vec{p} \leq {u}_{{v}^{′} \to f} , ∀ {v}^{′} ∈ N ( {f}^{′} ) ,$$
$${\vec{A}}_{{v}^{′} ⋀ {v}^{″}} ⊙ \vec{p} = ( {\vec{A}}_{{v}^{′}} ⊙ \vec{p} ) \cdot ( {\vec{A}}_{{v}^{″}} ⊙ \vec{p} ) , ∀ {v}^{′} \neq {v}^{″} ∈ N ( {f}^{′} ) ,$$
$$minimize / maximize {\vec{A}}_{p} ⊙ \vec{p} ,$$
where f′ is an auxiliary factor node corresponding to ρ, N(f′)={v₁, . . . , vₖ} and [symbol] ₚ is p's indicator vector.

6. The computer-implemented method of claim 1, wherein the set of logic formulas includes at least one of a propositional logic formula or a first-order logic formula.

7. The computer-implemented method of claim 6, wherein the first-order logic formula is universally and/or existentially quantified, and predicate arguments of the first-order logic formula have finite domains of values.

8. The computer-implemented method of claim 1, further comprising combining multiple sources of imprecise knowledge for outputting the probability interval.

9. A system comprising:
a processor;
a data bus coupled to the processor;
a memory coupled to the data bus; and
a computer-usable medium embodying a computer program code, the computer program code comprising instructions executable by the processor and configured to:
receive input including a set of logic formulas, a set of intervals representing lower and upper bounds on truth values of formulas in the set of logic formulas, and a query formula;
convert the logic formulas into a logical credal network (LCN) representation;
create a factor graph representation of the LCN representation; and
output a probability interval [l, u] of P(q), where P(q) represents a query for a given probability interval.

10. The system of claim 9, further comprising computing node-to-factor and factor-to-node messages in the factor graph representation.

11. The system of claim 10, wherein the node-to-factor and factor-to-node messages between nodes of the factor graph representation are lower and upper bounds on marginal probabilities.

12. The system of claim 10, wherein the instructions are further configured to solve a quadratic program encoding of the node-to-factor and factor-to-node messages and the query formula to obtain l≤P(q)≤u.

13. The system of claim 12, wherein the quadratic program is:
$${\sum }_{i = 1}^{K} {p}_{i} = 1 ,$$
$${p}_{i} \geq 0 , {∀}_{i} = 1 , … , K ,$$
$${l}_{{v}^{′} \to f} \leq {\vec{A}}_{{v}^{′}} ⊙ \vec{p} \leq {u}_{{v}^{′} \to f} , ∀ {v}^{′} ∈ N ( {f}^{′} ) ,$$
$${\vec{A}}_{{v}^{′} ⋀ {v}^{″}} ⊙ \vec{p} = ( {\vec{A}}_{{v}^{′}} ⊙ \vec{p} ) \cdot ( {\vec{A}}_{{v}^{″}} ⊙ \vec{p} ) , ∀ {v}^{′} \neq {v}^{″} ∈ N ( {f}^{′} ) ,$$
$$minimize / maximize {\vec{A}}_{p} ⊙ \vec{p} ,$$
where f′ is an auxiliary factor node corresponding to ρ, N(f′)={v₁, . . . , vₖ} and [symbol] ₚ is p's indicator vector.

14. The system of claim 9, wherein the set of logic formulas includes at least one of a propositional logic formula or a first-order logic formula.

15. The system of claim 14, wherein the first-order-logic formula is universally and/or existentially quantified, and predicate arguments of the first-order-logic formula have finite domains of values.

16. The system of claim 14, wherein the instructions are further configured to combine multiple sources of imprecise knowledge for outputting the probability interval.

17. A computer program product for improving matching in a probabilistic matching engine, the computer program product comprising a computer readable storage medium having program instructions embodied therewith, the program instructions executable by a computer to cause the computer to:
receive input including a set of logic formulas, a set of intervals representing lower and upper bounds on truth values of formulas in the set of logic formulas, and a query formula;
convert the logic formulas into a logical credal network (LCN) representation;
create a factor graph representation of the LCN representation; and
output a probability interval [l, u] of P(q), where P(q) represents a query for a given probability interval.

18. The computer program product of claim 17, wherein the instructions are further configured to compute node-to-factor and factor-to-node messages in the factor graph representation, wherein the node-to-factor and factor-to-node messages between nodes of the factor graph representation are lower and upper bounds on marginal probabilities.

19. The computer program product of claim 18, wherein:
the instructions are further configured to solve a quadratic program encoding of the node-to-factor and factor-to-node messages and the query formula to obtain l≤P(q)≤u; and
the quadratic program is:
$${\sum }_{i = 1}^{K} {p}_{i} = 1 ,$$
$${p}_{i} \geq 0 , {∀}_{i} = 1 , … , K ,$$
$${l}_{{v}^{′} \to f} \leq {\vec{A}}_{{v}^{′}} ⊙ \vec{p} \leq {u}_{{v}^{′} \to f} , ∀ {v}^{′} ∈ N ( {f}^{′} ) ,$$
$${\vec{A}}_{{v}^{′} ⋀ {v}^{″}} ⊙ \vec{p} = ( {\vec{A}}_{{v}^{′}} ⊙ \vec{p} ) \cdot ( {\vec{A}}_{{v}^{″}} ⊙ \vec{p} ) , ∀ {v}^{′} \neq {v}^{″} ∈ N ( {f}^{′} ) ,$$
$$minimize / maximize {\vec{A}}_{p} ⊙ \vec{p} ,$$
where f′ is an auxiliary factor node corresponding to ρ, N(f′)={v₁, . . . , vₖ} and [symbol] ₚ is p's indicator vector.

20. The computer program product of claim 17, wherein the set of logic formulas includes at least one of a propositional logic formula or a first-order logic formula.
